(19) United States
(12) Patent Application Publication
(10) Pub. No.: US 2005/0262125 A1
(43) Pub. Date: Nov. 24, 2005

(54) Data recording method and data recording device

(75) Inventor: Yuichi Kanai, Bisai (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/109,706

(22) Filed: Apr. 20, 2005

(30) Foreign Application Priority Data
May 18, 2004 (JP) 2004-147388

(51) Int. Cl. G06F 17/30

(52) U.S. Cl. 707/101

(57) ABSTRACT

Block of a given data size are set as the unit of storing thumbnail structures to a thumbnail file. When a flag indicating a fixed length (constant) is set as flag information of a header (header for recorded thumbnails), the thumbnail file is controlled to store one thumbnail structure in one block. On the other hand, when a flag indicating a variable block length (a multiple of the block size) is set as the flag information, the thumbnail file is controlled to store one thumbnail structure in one block or over plural blocks. The data capacity of the unit block is set to the block size contained in the header.

### BACKGROUND OF THE INVENTION

1. Field of the Invention

The present invention relates to a data recording method and a data recording device. More specifically, the invention relates to data recording method and device suitable to record file data in removable disks.

2. Description of the Related Art

The common way to store a data group in a file format in a recording medium is to store each data of the group as a separate file. An exception is a data group of which elements share the same meaning (for example, thumbnails) and can be integrated into one file. An advantage of storing a data group as one file is that the overhead accompanying opening and closing of files is lessened. When one file holds one data piece, N files have to be opened to read N data pieces. When all elements of a data group are held in one file, on the other hand, N data pieces can be read by opening one file. A disadvantage of storing a data group as one file is complicate data management, in other words, lowering of access performance from addition and deletion of data.

CD (Compact Disk), DVD (Digital Versatile Disk), removable HDD (Hard Disk Drive) and other portable recording media must have a common data configuration to ensure compatibility among all kinds of video recorders and PCs. Besides, it is desirable for video recorders, PCs and the like to have data format options from which to choose in accordance with the type of data they process or their design concepts. Formulating data formats that meet the requirement is therefore demanded.

JP2004-5495A discloses a technique for supporting recording and reproducing data in removable disks of different data formats.

### SUMMARY OF THE INVENTION

An object of the present invention is to provide a data recording method and a data recording device which can utilize a recording area with improved efficiency as needed and which ensure compatibility of a portable medium between different types of recorder/player. Another object of the present invention is to provide a data recording method and a data recording device which are capable of quick and easy data retrieval as well as easy data management of in adding and deleting a data structure.

A first aspect of the present invention is comprehended as a data recording method to record and store plural data structures in one file. The data recording method according to the first aspect sets a block of a given data size as the unit of storing the data structures. The method also sets size information, which determines the data size of the blocks, and flag information, which determines whether only a single block or one or more blocks are used to store one data structure, as management information for the file. In the case where one or more blocks are used to store one data structure, the method sets, as management information for each of the data structure, information that determines the number of blocks used to store the data structure.

The data recording method according to the first aspect can also set, as information for the data structure, information that determines whether the data structure is erasable or not. The information that determines whether a data structure is erasable or not can be information indicating the link count of the data structure. In this case, each of the data structure is determined as erasable when its link count is 0.

In the data recording method according to the first aspect, when a new data structure is to be stored in a file, the information that determines the number of blocks used to store the data structure and the information that determines whether the data structure is erasable or not may be consulted to detect an erasable data structure that is larger in data size than the new data structure and the new data structure may be written over the detected data structure.

In the data recording method according to the first aspect, when the data structure that is to be overwritten with the new data structure has one or more blocks left after the overwriting, the information that determines whether the data structure is erasable or not of a data structure associated with the remaining block(s) may be set to “erasable” while information indicating the data structure associated with the remaining block(s) hold invalid data is set as the management information for the data structure of the remaining block(s).

In the data recording method according to the first aspect, when there is no erasable data structure that is larger in data size than the new data structure, the new data structure may be stored at the end of the file.

In the data recording method according to the first aspect, the data structures may contain thumbnail data as main data.

A second aspect of the present invention is comprehended as a data recording device to record and store plural data structures in one file. The data recording device according to the second aspect has block setting means for setting a block of a given data size as the unit of storing the data structures, and a first information setting means for setting size information, which determines the data size of the block, and flag information, which determines whether only a single block or one or more blocks are used to store one data structure, as management information for the file in a data format.

The recording device according to the second aspect may have, in the case where one or more blocks are used to store one data structure, a second information setting means for setting, as management information for each of the data structure in the data format, information that determines the number of blocks used to store the data structure.

In the recording device according to the second aspect, the second information setting means may set, as the management information for each of the data structure in the data format, information that determines whether the data structure is erasable or not.

In the recording device according to the second aspect, the information that determines whether the data structure is erasable or not can be information indicating the link count of the data structure. In this case, each of the data structures is determined as erasable when its link count is 0.

The data recording device according to the second aspect may be structured such that, when a new data structure is to be stored in a file, the information that determines the number of blocks used to store the data structure and the information that determines whether the data structure is erasable or not may be consulted to detect an erasable data structure that is larger in data size than the new data structure and the new data structure may be written over the detected data structure.

The data recording device according to the second aspect may be structured such that, when the data structure that is to be overwritten with the new data structure has one or more blocks left after the overwriting, the information that determines whether the data structure is erasable or not of a data structure associated with the remaining block(s) may be set to “erasable” while information indicating the data structure associated with the remaining block(s) hold invalid data is set as the management information for the data structure of the remaining block(s) in the data format.

The data recording device according to the second aspect maybe structured such that, when there is no erasable data structure that is larger in data size than the new data structure, the new data structure may be stored at the end of the file.

In the data recording device according to the second aspect, the data structures may contain thumbnail data as main data.

According to the invention having the above aspects, the block(s) allocated to the file can be set to any size by setting the size information suitably.

It is also possible to apply any data storing method to the file by setting the flag information suitably. For instance, when the flag information is set to suit a method that uses a single block for data structure storage, a data storing method in which each block has one data structure can applied to the file. The size information in this case is set to give each block a size large enough for a data structure that is expected to be stored.

Setting the flag information to suite a method that uses one or more blocks for data structure storage makes it possible to employ a data storing method in which one data structure is stored in one block or over plural blocks. If in this case the size information is set to give the block(s) a small size, a recording area can be utilized with improved efficiency. It also makes the start point of a block easy to find since blocks are used in an integral multiple to store one data structure. As a result, data retrieval is quick and easy irrespective of whether data structure is of variable length or not, and data management in adding and deleting a data structure is facilitated.

Note that, in the case where the flag information is set to the method that uses one or more blocks for data structure storage, when the size of the data structure is small, the data structure can be stored in one block.

The file format of the file can be identified by consulting the size information and the flag information which are set as file management information. The block length of a data structure can be recognized by consulting the information that determines the number of blocks used to store the data structure which is set as the management information for each of the data structures. Thus, a recorder/player loaded with the recording medium recorded by different type of a recorder can recognize the file format and block size of a file recorded in the recording medium. Thus, the file recorded in the recording medium can be reproduced by any kind of recorder/player compatibly.

The present invention is also capable of setting an overwritable data structure by merely setting, as the management information for each of the data structures, information that determines whether a data structure is erasable or not. Invalidating the information turns a data structure from erasable to unerasable, and thereby makes good use of recorded data structures.

Setting the information that determines whether a data structure is erasable or not as the management information for each of the data structures makes it possible to detect an overwritable data structure by consulting the erasability information. Also, blocks remaining after overwriting can be invalidated by setting the erasability information to improve the efficiency of processing data structures.

The term “data structure” in the above aspects corresponds to the term “thumbnail structure” in the following embodiment. The “size information” in the above aspects corresponds to “block size (length of block size)” in the following embodiment. The “management information for the file” in the above aspects corresponds to “header (header for recorded thumbnails)” in the following embodiment. The “management information for the data structure” in the above aspects corresponds to “header (header for each thumbnail)” in the following embodiment. The “information indicating the link count of the data structure” in the above aspects corresponds to “link count” in the following embodiment. The “information indicating that a data structure holds invalid data” in the above aspects corresponds to “broken bit” in the following embodiment. The functions of the means in the second aspect are carried out by a system controller 109 in the following embodiment.

### BRIEF DESCRIPTION OF THE DRAWINGS

The foregoing and other objects of the present invention, and its novel characteristics, will be understood more clearly from the following detailed description when read in conjunction with the accompanying drawings in which:

FIG. 1 shows the configuration of a digital television recorder/player according to an embodiment;

FIG. 2 shows a directory/file configuration according to the embodiment;

FIG. 3 shows the data configuration of a TV program management file according to the embodiment;

FIG. 4 shows a data configuration of a thumbnail file according to the embodiment;

FIG. 5 shows a data configuration of a thumbnail file according to the embodiment;

FIG. 6 is a diagram illustrating processing of newly adding a thumbnail structure in accordance with the embodiment; and

FIG. 7 is a flow chart of processing of newly adding a thumbnail structure in accordance with the embodiment.

### DETAILED DESCRIPTION OF THE PREFERRED EMBODIMENT

An embodiment of the present invention will be described below with reference to the accompanying drawings. The following embodiment is for exemplification only, and is not to limit the scope of the present invention.

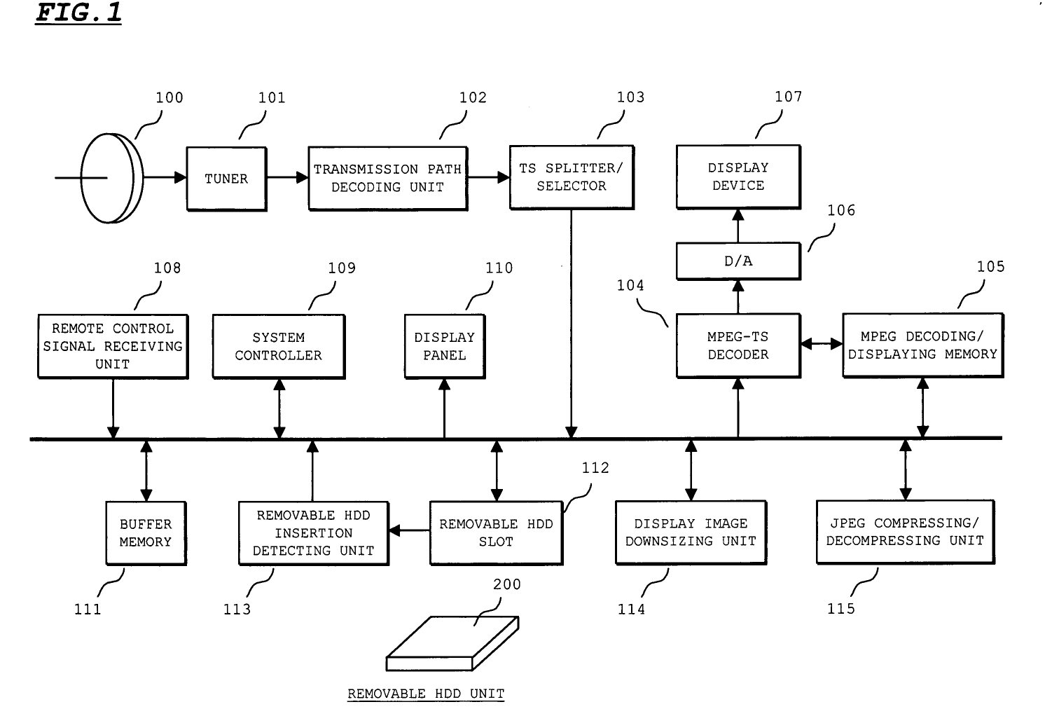

FIG. 1 shows the configuration of a digital television recorder/player according to this embodiment. The digital television recorder/player uses a removable HDD unit as an external storage device, and plays received SD (Standard Definition) video information or HD (High Definition) video information or to records the video information in the removable HDD unit.

As shown in FIG. 1, the digital television recorder/player is composed of an antenna 100, a tuner 101, a transmission path decoding unit 102, a TS splitter/selector 103, an MPEG-TS decoder 104, an MPEG decoding and displaying memory 105, a D/A converter 106, a display device 107, a remote control signal receiving unit 108, a system controller 109, a display panel 110, a buffer memory 111, a removable HDD slot 112, a removable HDD insertion detecting unit 113, a display image downsizing unit 114, and a JPEG compressing/decompressing unit 115.

A removable HDD unit 200 is a recording medium used in the digital television recorder/player.

The basic operation of recording and playing a digital broadcast is described hereinafter with reference to FIG. 1.

The antenna 100 receives digitally modulated signals. Under the instruction of the system controller 109, the tuner 101 picks up a channel selected by a user and extracts signals of the selected channel from the signals received by the antenna 100. The transmission path decoding unit 102 decodes the signals extracted by the tuner 101 in an audio/video format encoded by MPEG2, and outputs the audio/video data to the TS splitter/selector 103.

The TS splitter/selector 103 outputs the audio/video data to the MPEG-TS decoder 104 when the audio/video data is not to be recorded. The audio/video data is decoded by the MPEG-TS decoder 104, and then outputted to the display device 107 via the D/A converter 106 to be displayed on the display device 107. When the audio/video data is to be recorded, the TS splitter/selector 103 outputs the audio/video data to the buffer memory 111. The audio/video data is sequentially put through file formatting by the system controller 109 and is recorded in the removable HDD unit 200 through the removable HDD slot 112.

To reproduce file data recorded in the removable HDD unit 200, the user operates a remote controller (not shown in the drawing) and selects audio/video data corresponding to the title of the TV program to be played. This causes the audio/video data to be read out of the removable HDD unit 200 and outputted to the MPEG-TS decoder 104. The audio/video data is decoded by the MPEG-TS decoder 104 and then outputted to the display device 107 via the D/A converter 106 to be displayed on the display device 107.

The title of a TV program to be played is selected by referring to a thumbnail image associated with each audio/video data. A thumbnail image is a downsized frame image, and usually serves as a pictorial index. For one audio/video data file (TV program), a downsized image (thumbnail image) of a image representing the file is set to make an index image of the audio/video data file. A thumbnail image is created in accordance with an audio/video data file, and recorded in the removable HDD unit 200.

How a thumbnail image is created and recorded is described next.

First, the user selects a desired TV program from a list of recorded programs and plays the selected program on the digital television recorder/player. Then the user pauses the video at an image of which a thumbnail image is to be created, and inputs an instruction to create a thumbnail image from the image to the digital television recorder/player through the not-shown remote controller. In response to the input, a digitized display image held in the MPEG decoding and displaying memory 105 is downsized to a given size by the display image downsizing unit 114. For instance, a 720 pixels×480 pixels (l×w) image is reduced down and across to 1/4 (180 pixels×120 pixels). The downsized image is compressed by the JPEG compressing/decompressing unit 115. The compressed thumbnail data is recorded in the removable HDD unit 200 in association with the TV program information (audio/video data file).

After one or more thumbnail image data are recorded in this manner, the user instructs the digital television recorder/player to display a list of TV programs recorded in the removable HDD unit 200. Upon reception of the instruction, thumbnail data associated with the program information are read out of a thumbnail file. The thumbnail data are decompressed by the JPEG compressing/decompressing unit 115. The decompressed thumbnail data are written in the MPEG decoding and displaying memory 105 to be displayed on the display device 107 via the MPEG-TS decoder 104 and the D/A converter 106.

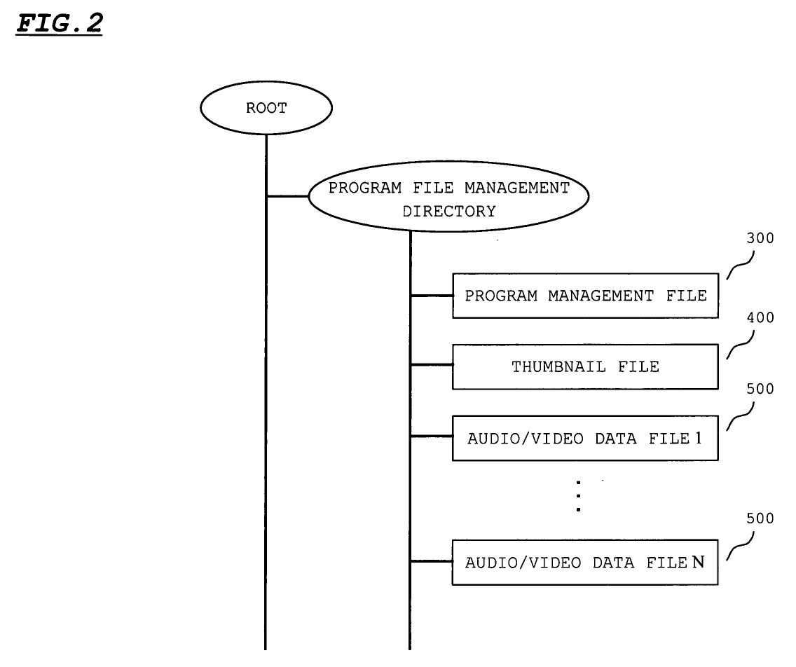

FIG. 2 shows a directory/file configuration for when a TV program is recorded in the removable HDD 200.

As shown in FIG. 2, information relating to recorded TV programs is all under a program file management directory. A program management file 300 is a file for managing all of recorded TV programs. An audio/video data file 500 holds program data (audio/video data) having an MPEG-TS format. A thumbnail file 400 is a single file where thumbnail image information of every recorded program is held. The configuration of the thumbnail file 400 will be described later in detail.

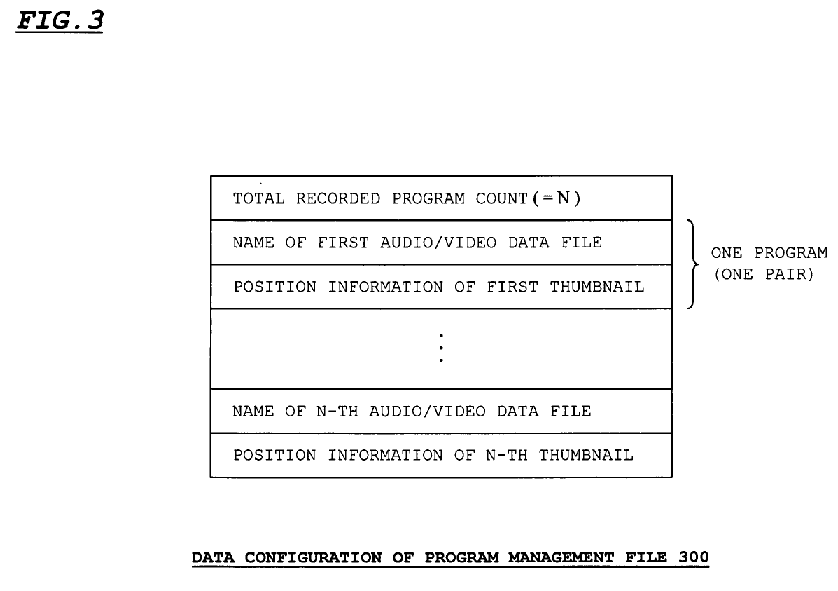

FIG. 3 shows the configuration of the program management file 300.

The program management file 300 is a file where management information of every TV program recorded in the hard disk is recorded. The program management file 300 first stores the total count of TV programs recorded. Here, the total recorded program count is N. Thereafter, an audio/video data file name and position information (the start point on the file and thumbnail data length) of a thumbnail associated with the audio/video data file name is stored as a pair. The number of pairs matches the total recorded program count N, and the N pairs are stored in succession. The program management file 300 is consulted to make retrieval of a TV program recorded in the hard disk quicker and easier, and enables the digital television recorder/player to manage the association between thumbnail image information and a program file.

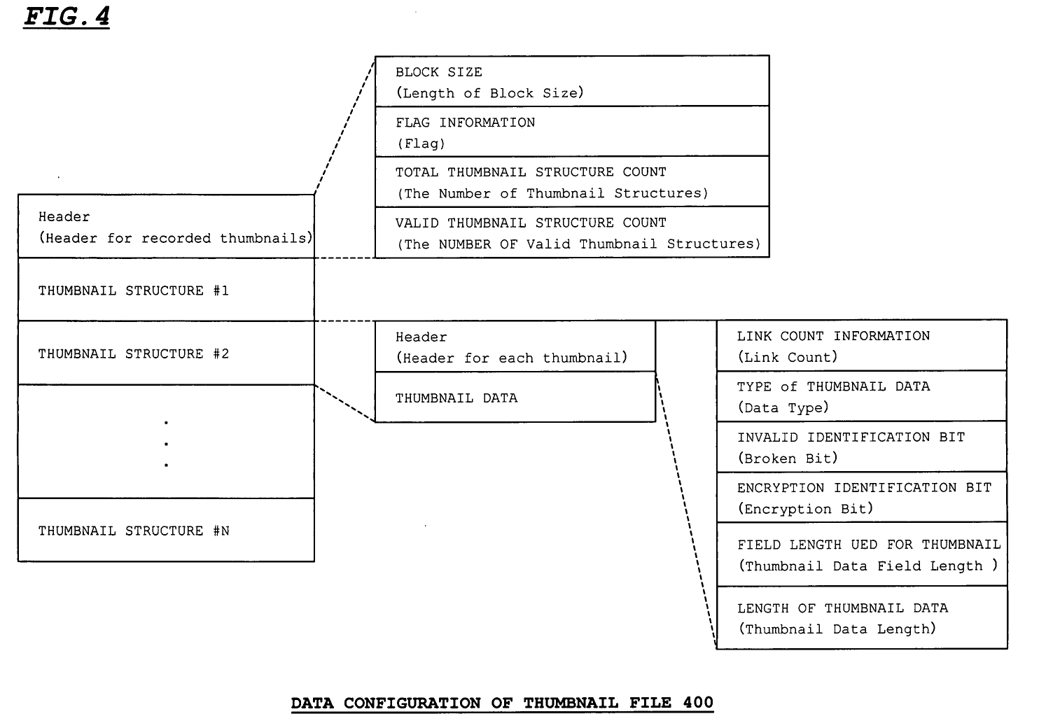

FIG. 4 shows the basic configuration of the thumbnail file 400.

The thumbnail file 400 first stores a header of the entire thumbnail file (header for recorded thumbnails). Thereafter, thumbnail structures are stored in order. The header for recorded thumbnails contains a block size (length of a block size) and flag information (flag), which determines whether a thumbnail structure has a fixed length (constant) or a length corresponding to a multiple of the block size. Stored next are the total count of thumbnail structures contained in this file (the number of thumbnail structures) and the number of thumbnail structures out of the total thumbnail structure count that are valid (in use) (the number of valid thumbnail structures).

Each thumbnail structure is composed of header information (header for each thumbnail) and thumbnail data. The header for each thumbnail contains data format information (data format) composed of link count information (link count), which indicates the total count of links linked to this thumbnail structure by the thumbnail position information of FIG. 3, a type of thumbnail data (data type), a invalid identification bit (broken bit), which indicates whether the thumbnail data is broken or not, and an encryption identification bit (encryption bit), which indicates whether the thumbnail data is encrypted or not.

The header for each thumbnail also contains, after the data format information, a field length used for the thumbnail (thumbnail data field length) and a length of the thumbnail data (thumbnail data length). A thumbnail data field length is a data capacity obtained by subtracting a data capacity that is used to store the header information (header for each thumbnail) from the data capacity of blocks used to store the thumbnail data structure. A thumbnail data length is the data length of the thumbnail data.

A block of a given data size is set as the unit of storing thumbnail structures to the thumbnail file. When a flag indicating a fixed length (constant) is set as the flag information of the header (header for recorded thumbnails) shown in FIG. 4, the thumbnail file is controlled to store one thumbnail structure in one block without fail. In this case, the data capacity of the unit block of the thumbnail file is set to the block size contained in the header (header for recorded thumbnails).

On the other hand, when a flag indicating a variable block length, namely, a multiple of the block size, is set as the flag information of the header (header for recorded thumbnails) shown in FIG. 4, the thumbnail file is controlled to store one thumbnail structure in one block or over plural blocks. In this case, a data capacity obtained by subtracting a data capacity that is used to store the header information (header for each thumbnail) from the data capacity of blocks used to store the thumbnail structure is set as the thumbnail data field length in the header information (header for each thumbnail).

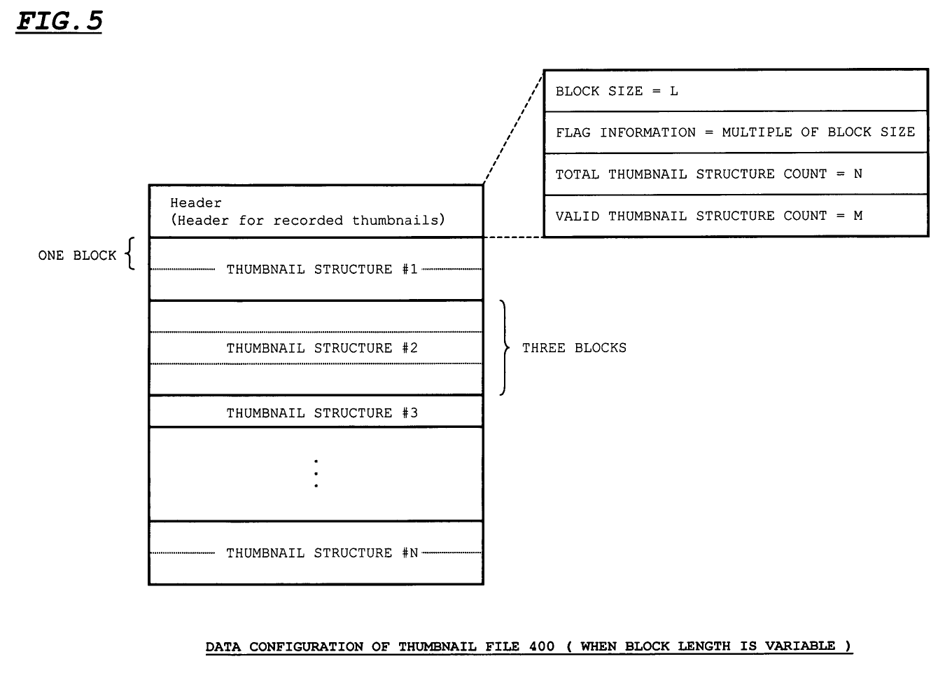

FIG. 5 shows an example of how data is stored when the flag information indicates a variable block length. Here, the block size in the header (header for recorded thumbnails) is set to L, and one thumbnail structure is stored in a field expressed in a multiple of the block size. In FIG. 5, two blocks are used to store a thumbnail structure #1 whereas three blocks are used to store a thumbnail structure #2.

Employing such a format enables the digital television recorder/player to balance improvement of the efficiency in storing thumbnail structures and the ease of adding, deleting and retrieving thumbnail structures. For instance, in digital broadcasting, setting the data capacity of a thumbnail structure of SD screen size to the block size makes it possible to express a thumbnail of HD screen size in a multiple of the block size.

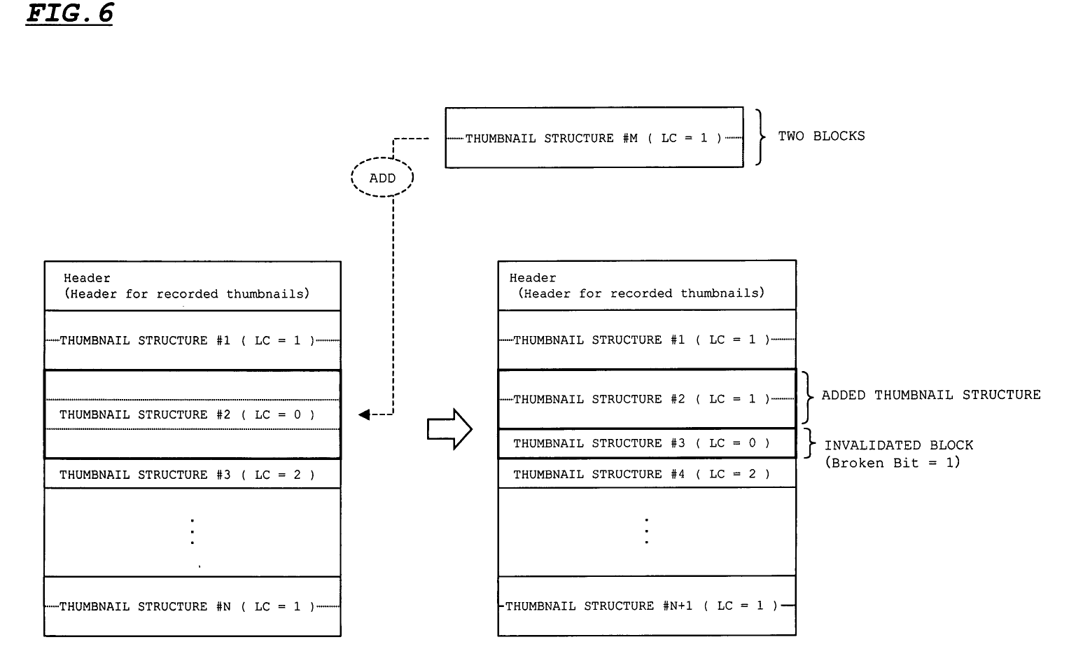

FIG. 6 shows an example of processing of adding a new thumbnail structure when the block length is variable.

Before FIG. 6 is described, a few supplemental explanations will be given on the link count information (link count). As has been described, the link count information indicates the total count of links linked from the program management file. For example, when a program file is edited to create a digest, the user may want to use an existing thumbnail image of this program for a thumbnail image of the digest as it is. In this case, the existing thumbnail image is linked to the audio/video file of the digest instead of newly creating the same thumbnail image, and the link count information (linkcount) of this thumbnail image is increased by 1.

The link count information (link count) set in the header information (header for each thumbnail) of a thumbnail structure is changed as the count of links linked to the thumbnail image changes. In some cases including when a program file from which a link is linked is erased, the link count of a thumbnail image can be 0. A thumbnail structure whose link count is 0 is erasable.

The information on the number of valid thumbnail structures which is contained in the header (header for recorded thumbnails) of the thumbnail file indicates the total count of thumbnail structures whose link count is not 0.

To add a new thumbnail structure to the thumbnail file when the block length is variable, the simplest processing method is to add the new thumbnail structure at the end of the thumbnail file. However, this method leaves erasable thumbnail structures to which no link is linked among thumbnail structures that have been stored in the thumbnail file and thus wastes the hard disk capacity.

This problem can be solved by employing a method of FIG. 6 in which a thumbnail structure that has a link count (LC in FIG. 6) of 0 and that is equal to or larger than the new thumbnail structure in size (block count) is overwritten with the new thumbnail structure.

In the case where the thumbnail structure to be overwritten and the thumbnail structure to be newly added have the same size, the overwriting is carried out without taking any special step. On the other hand, when the new thumbnail structure is smaller in size than the thumbnail structure to be overwritten, the overwriting produces as many remaining blocks as the difference between the size (block count) of the thumbnail structure to be overwritten and the size (block count) of the thumbnail structure to be newly added. The remaining blocks are totally useless structures.

In this case, header information (header for each thumbnail) is added to a remaining block, and the link count information and the broken bit are set to 0 and 1, respectively (link count=0, broken bit=1). “Broken bit=1” indicates that data of this thumbnail structure cannot be reproduced. Thus the overall consistency of the thumbnail file is maintained.

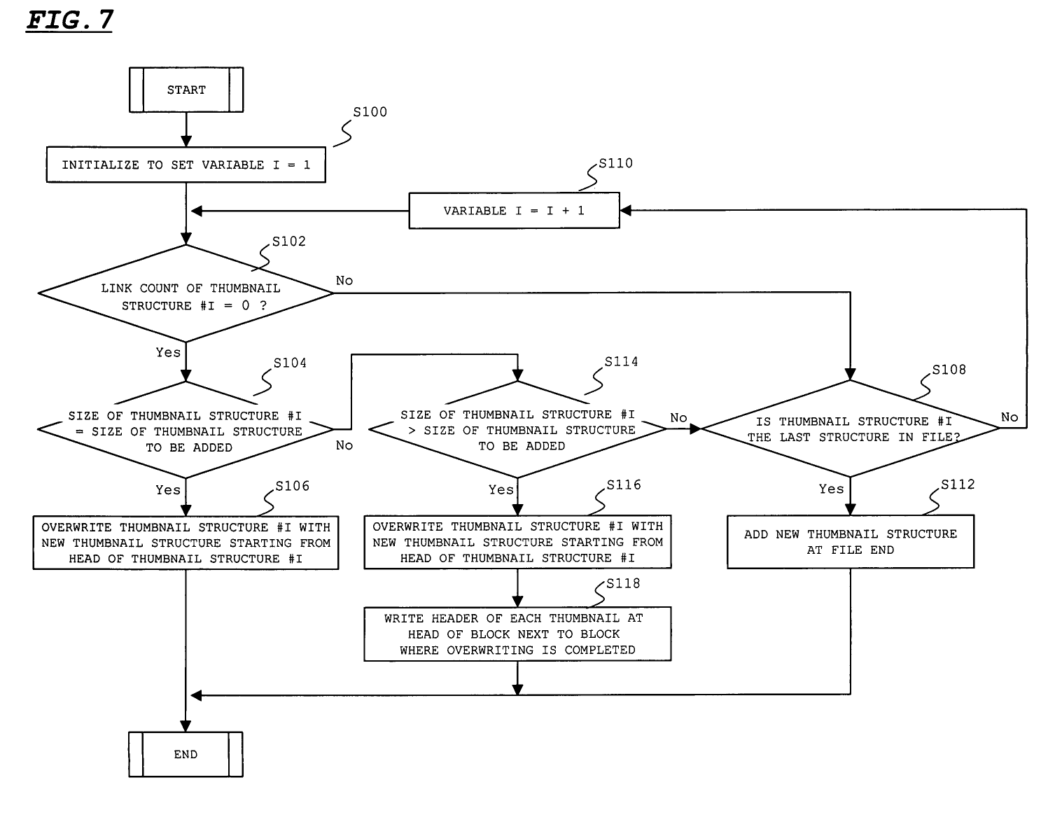

FIG. 7 shows a processing flow for newly adding a thumbnail structure when the block length is variable. This processing flow is executed when a thumbnail image of a newly recorded TV program is created and recorded, not when merely the link count of an existing thumbnail image is changed.

As the processing flow is started, the first step is initialization which sets a variable I to 1 (Step S100). Next, the link count of a thumbnail structure #I is checked (Step S102). In the case where the link count is not 0 (Step S102: No), and if the thumbnail structure #I is not at the end of the thumbnail file (Step S108: No), the variable I is increased by 1 (Step S110) and the link count of the next thumbnail structure #I is checked (Step S102). If the thumbnail structure #I is at the end of the thumbnail file (Step S108: Yes), the new thumbnail structure is added at the end of the thumbnail file (Step S112).

In the case where the link count of the thumbnail structure #I is 0 at Step S102 (Step S102: Yes), the size of the thumbnail structure #I is compared against the size (block count) of the thumbnail structure to be newly added. If the two have the same size (Step S104: Yes), the thumbnail structure #I is overwritten with the new thumbnail structure starting from the head block of the thumbnail structure #I (Step S106), and the processing is ended.

In the case where the comparison between the thumbnail structure #I and the new thumbnail structure reveals that the new thumbnail structure is larger in size than the thumbnail structure #I (Step S104: No, Step S114: No), the processing proceeds to Step S108 to repeat the steps described above.

In the case where the comparison between the thumbnail structure #I and the new thumbnail structure reveals that the thumbnail structure #I is larger in size than the new thumbnail structure (Step S104: No, Step S114: Yes), the thumbnail structure #I is overwritten with the new thumbnail structure starting from the head block of the thumbnail structure #I (Step S116).

Then header information is written at the block next to the block where the overwriting is completed (Step S118). At this point, the parameters in the header information are set as follows:
Link count=0
Broken bit=1 (which means that this thumbnail cannot be reproduced)
Thumbnail field length=(the data capacity of blocks of the original thumbnail structure #I)−(the data capacity of blocks of the new thumbnail structure)−(the data capacity of the header information)

Now a description of an embodiment of the present invention is completed. The present invention is not limited to the above embodiment, and various modifications can be made. For instance, the present invention, which is applied to recording processing of thumbnail file data in the above embodiment, is applicable to recording processing of other file data than thumbnail file data. The present invention is also applicable to other data recording devices than the digital television recorder/player.

The present invention can take various modified embodiments within the range of a technical concept disclosed in the scope of patent claims.

1. A data recording method for recording and storing plural data structures in one file, comprising;
setting a block of a given data size as the unit of storing the data structures;
setting size information, which determines the data size of the block, and flag information, which determines whether only a single block or one or more blocks are usable to store one data structure, as management information for the file; and
setting, as management information for each of the data structures, information that determines the number of blocks used to store the data structure, in the case where one or more blocks are used to store one data structure.

2. A data recording method according to claim 1,
wherein as the management information for each of the data structures, information that determines whether the data structure is erasable or not is set.

3. A data recording method according to claim 2,
wherein the information that determines whether the data structure is erasable or not is information indicating the link count of the data structure, and each of the data structures is determined as erasable when its link count is 0.

4. A data recording method according to claim 2,
wherein when a new data structure is to be stored in the file, the information that determines the number of blocks used to store the data structure and the information that determines whether the data structure is erasable or not are consulted to detect an erasable data structure that is larger in data size than the new data structure and the new data structure is written over the detected data structure.

5. A data recording method according to claim 4,
wherein when the data structure that is to be overwritten with the new data structure has one or more remaining blocks left after the overwriting, the information that determines whether the data structure is erasable or not of a data structure associated with the remaining block(s) is set to “erasable” while information indicating the data structure associated with the remaining block(s) hold invalid data is set as the management information for the data structure of the remaining block(s).

6. A data recording method according to claim 4,
wherein when there is no erasable data structure that is larger in data size than the new data structure, the new data structure is stored at the end of the file.

7. A data recording method according to any one of claims 1 to 6,
wherein the data structures contain thumbnail data as main data.

8. A data recording device for recording and storing plural data structures in one file, comprising:
block setting means for setting a block of a given data size as the unit of storing the data structures; and
a first information setting means for setting size information, which determines the data size of the block, and flag information, which determines whether only a single block or one or more blocks are usable to store one data structure, as management information for the file in a data format.

9. A recording device according to claim 8, further comprising:
a second information setting means for setting, as management information for each of the data structures in the data format, information that determines the number of blocks used to store the data structure, in the case where one or more blocks are used to store one data structure.

10. A recording device according to claim 9,
wherein the second information setting means sets, as the management information for each of the data structures in the data format, information that determines whether the data structure is erasable or not.

11. A recording device according to claim 10,
wherein the information that determines whether the data structure is erasable or not is information indicating the link count of the data structure, and each of the data structures is determined as erasable when its link count is 0.

12. A recording device according to claim 10,
wherein when a new data structure is to be stored in the file, the information that determines the number of blocks used to store the data structure and the information that determines whether the data structure is erasable or not are consulted to detect an erasable data structure that is larger in data size than the new data structure and the new data structure is written over the detected data structure.

13. A recording device according to claim 12,
wherein when the data structure that is to be overwritten with the new data structure has one or more remaining blocks that is not used for the overwriting, the information that determines whether the data structure is erasable or not of a data structure associated with the remaining block(s) is set to “erasable” while information indicating the data structure associated with the remaining block(s) hold invalid data is set as the management information for the data structure of the remaining block(s) in the data format.

14. A recording device according to claim 12, wherein when there is no erasable data structure that is larger in data size than the new data structure, the new data structure is stored at the end of the file.

15. A recording device according to any one of claims 8 to 14, wherein the data structures contain thumbnail data as main data.
